(19) United States
(12) Patent Application Publication
(10) Pub. No.: US 2023/0280736 A1
(43) Pub. Date: Sep. 7, 2023

(54) COMPREHENSIVE ANALYSIS MODULE FOR DETERMINING PROCESSING EQUIPMENT PERFORMANCE

(71) Applicant: Applied Materials, Inc., Santa Clara, CA (US)

(72) Inventors: Dermot Patrick Cantwell, Sunnyvale, CA (US); Hui-Ling Han, Alameda, CA (US); Moon Kyu Oh, Santa Clara, CA (US); Weili Li, San Jose, CA (US)

(21) Appl. No.: 18/175,538

(22) Filed: Feb. 28, 2023

Related U.S. Application Data
(60) Provisional application No. 63/315,926, filed on Mar. 2, 2022.

(51) Int. Cl. G05B 19/4063; G05B 23/02

(52) U.S. Cl. CPC G05B 19/4063; G05B 23/0281; G05B 2223/02; G05B 2219/37001

(57) ABSTRACT

A method includes receiving, by a processing device, first data indicative of a processing recipe. The method further includes receiving second data. The second data includes operational data associated with the processing recipe. The method further includes receiving third data. The third data includes historical data associated with the processing recipe. The method further includes performing analysis indicative of performance of a processing chamber based on the first, second, and third data. The method further includes causing performance of a corrective action in view of the analysis.

### RELATED APPLICATION

This application claims the benefit of U.S. Provisional Application No. 63/315,926, filed 2 Mar. 2022, the content of which is hereby incorporated by reference in its entirety.

### TECHNICAL FIELD

The present disclosure relates to diagnostic methods for determining faults in manufacturing equipment, and in some embodiments, a comprehensive analysis module for improving consistency and/or reliability of processing equipment.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Understanding and controlling properties within the manufacturing chamber aids in consistent production of products.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

A method includes receiving, by a processing device, first data indicative of a processing recipe. The method further includes receiving second data. The second data includes operational data associated with the processing recipe. The method further includes receiving third data. The third data includes historical data associated with the processing recipe. The method further includes performing analysis indicative of performance of a processing chamber based on the first, second, and third data. The method further includes causing performance of a corrective action in view of the analysis.

In another aspect of the disclosure, a method includes receiving, by a processing device, first data, wherein the first data comprises a processing recipe. The method further includes performing first analysis on the processing recipe. The first analysis includes comparing the first data to one or more best known methods (BKMs) related to the first data. The method further includes receiving second data. The second data comprises first operational data. The first operational data is generated from a first number of processing runs using the processing recipe. The method further includes performing second analysis on the second data. The method further includes receiving third data. The third data includes second operational data. The second operational data is generated from a second number of processing runs using the processing recipe. The method further includes performing third analysis on the third data. The second number is greater than the first number. The method further includes causing performance of a corrective action based on the first analysis, second analysis, and third analysis.

In another aspect of the present disclosure, a non-transitory machine-readable storage medium stores instructions which, when executed, cause a processing device to perform operations. The operations include receiving first data indicative of a processing recipe. The operations further include receiving second data. The second data includes operational data associated with the processing recipe. The operations further include receiving third data. The third data includes historical data associated with the processing recipe. The operations further include performing analysis indicative of performance of a manufacturing system. The analysis is based on the first, second, and third data. The operations further include causing performance of a corrective action in view of the analysis.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of an example data set generator, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for using a comprehensive analysis module for performing a corrective actions, according to some embodiments.

FIG. 4C is a flow diagram of a method for utilizing a comprehensive analysis module for performance of a corrective action, according to some embodiments.

FIG. 5A depicts a flow of data through an automated comprehensive analysis module, according to some embodiments.

FIG. 5B is a block diagram depicting various analysis categories included in a comprehensive analysis module, according to some embodiments.

FIG. 5C is a flow diagram depicting use of a comprehensive analysis module, according to some embodiments.

FIG. 6 is a diagram depicting an example set of operating windows, according to some embodiments.

FIG. 7 depicts an example graphical user interface (GUI) for interacting with a comprehensive analysis module, according to some embodiments.

FIG. 8 is a block diagram illustrating a computer system, according to some embodiments.

### DETAILED DESCRIPTION

Described herein is a system and methods for automating recipe and data analysis for processing chambers. The systems and methods described herein may be used for ascertaining system health, performing anomaly detection, providing translation of skilled operator knowledge, collection and implementation of best known methods (BKMs), etc.

Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point.

Operations of a manufacturing system may be monitored. Monitoring a manufacturing system may include recording and storing recipe data, equipment constant data, sensor data, or metrology data. Monitoring a manufacturing system may allow an operator to make changes to the manufacturing system. Monitoring a manufacturing system may allow improvements to be made to the manufacturing system.

In some conventional systems, a recipe may be checked for compliance with best known methods (BKMs) by a subject matter expert. A recipe may be designed for a target outcome and rely upon human interaction to determine whether the recipe is designed in accordance with one or more BKMs. In some conventional systems, sensor data may be analyzed to diagnose non-ideal performance, recommend corrective actions, or the like. In some conventional systems, data associated with a series of manufacturing operations (e.g., a number of processed substrates) may be analyzed to diagnose changing or drifting performance.

In some conventional systems, data associated with different stages of a manufacturing process is treated independently. Data generated before a substrate is processed, such as recipe data and equipment constant data, may be analyzed for anomalies or errors. Any errors found in this stage may be corrected. Data associated with one or more substrates may be analyzed in a separate stage. Data associated with substrates (e.g., sensor data) may be analyzed to determine whether components of a processing system are performing as expected, are failing, or the like. Data associated with a number of substrates over a period of time may be analyzed to understand slower changes in the manufacturing equipment.

In some conventional systems, data is imported to an analysis module on a case-by-case basis. For example, data suspected to be associated with a manufacturing process that does not meet performance thresholds may be provided to an analysis module. In some systems, analysis of various stages of manufacturing may be performed separately. Recipe data analysis is used to update recipe data, sensor data analysis is utilized to update operations impacting sensor data, etc.

In some conventional systems, updates related to a stage of processing (e.g., recipe and equipment stage, processing stage, processing chamber aging stage) may be performed based on data collected during that stage of processing.

In some conventional systems, data is screened and/or analyzed by subject matter experts. Different experts with different levels of experience may screen data from different stages of substrate processing. Different experts may analyze data from different stages of substrate processing. Subject matter experts may rely on metrology data of processed substrates to determine which data may provide insight into operations of the manufacturing system.

Methods and systems of the present disclosure may address deficiencies of conventional solutions. In some embodiments, a comprehensive analysis module is enabled. The comprehensive analysis module utilizes data across multiple stages of processing. The comprehensive analysis module may recommend corrective actions associated with multiple stages of processing. The comprehensive analysis module may generate output for review by a user, such as a subject matter expert. The comprehensive analysis module may screen data that may be of interest to a user, such as data indicative of degrading manufacturing equipment components.

Systems and methods described herein may automatically synthesize a large volume of data (e.g., recipe data, hardware parameter data, sensor data, etc.) to generate data indicative of system health, recipe accuracy, recommended corrective actions, etc. Data related to multiple stages of manufacturing may be provided to the comprehensive analysis module. Data related to a pre-manufacturing stage (e.g., recipe data, processing chamber set-up data, equipment constant data, etc.) may be analyzed by the comprehensive analysis module. Data related to substrate manufacturing processes (e.g., sensor data, hardware parameter data, etc.) may be utilized by the comprehensive analysis module. Data related to long-term analysis (e.g., shifts in data over many substrate processing operations) may be utilized by the comprehensive analysis module.

In some embodiments, the comprehensive analysis module may utilize data analysis to inform further data collection. Data from processing of one substrate may be used to determine corrective actions to be taken in association with a second substrate. Data from one stage of processing may be used to determine actions to be taken in association with a later stage of processing. Data that may be indicative of reduced substrate performance may be used to schedule further actions in association with the substrate, chamber, tool, or the like. Data indicative of reduced substrate performance may be used to schedule the substrate for metrology operations.

In some embodiments, data analysis may include rule-based processing. In some embodiments, data analysis may include if/then processing. In some embodiments, data analysis may include statistical metrics. In some embodiments, data analysis may include statistical models. In some embodiments, data analysis may include providing data to a trained machine learning model. In some embodiments, output from the trained machine learning model may be indicative of one or more recommended corrective actions.

In some embodiments, analysis results may be displayed on a user interface. The user interface may alert a user to conditions and/or operations of one or more manufacturing systems. The user interface may summarize performance of processing operations (e.g., steps). The user interface may summarize performance of processing procedures (e.g., performance associated with a processed substrate). The user interface may summarize performance of a process chamber. The user interface may summarize performance of a process tool. The user interface may summarize performance of a group of process tools (e.g., a manufacturing facility). The user interface may display details of rule violations, violations of BKMs, recipe data, sensor data, etc.

In some embodiments, the comprehensive analysis module may be used for performance of a corrective action. Some corrective actions may be taken by the comprehensive analysis module. Some corrective actions may be recommended to a user by the comprehensive analysis module. Corrective actions may include updating process recipes, updating equipment constants, updating BKMs, scheduling maintenance, scheduling component replacement, scheduling additional measurements or tests, etc.

Aspects of the present disclosure provide technical advantages over previous approaches. A comprehensive analysis module enables data from various stages of processing to be used together to improve future substrate processing procedures. A comprehensive analysis module enables recommendations of corrective actions based on any stage of processing, or multiple stages of processing. A comprehensive analysis module utilizes a broad selection of data for decision making, analysis, corrective actions, etc.

In some aspects of the present disclosure, a method includes receiving, by a processing device, first data indicative of a processing recipe. The method further includes receiving second data. The second data includes operational data associated with the processing recipe. The method further includes receiving third data. The third data includes historical data associated with the processing recipe. The method further includes performing analysis indicative of performance of a processing chamber based on the first, second, and third data. The method further includes causing performance of a corrective action in view of the analysis.

In another aspect of the disclosure, a method includes receiving, by a processing device, first data, wherein the first data comprises a processing recipe. The method further includes performing first analysis on the processing recipe. The first analysis includes comparing the first data to one or more best known methods (BKMs) related to the first data. The method further includes receiving second data. The second data comprises first operational data. The first operational data is generated from a first number of processing runs using the processing recipe. The method further includes performing second analysis on the second data. The method further includes receiving third data. The third data includes second operational data. The second operational data is generated from a second number of processing runs using the processing recipe. The method further includes performing third analysis on the third data. The second number is greater than the first number. The method further includes causing performance of a corrective action based on the first analysis, second analysis, and third analysis.

In another aspect of the present disclosure, a non-transitory machine-readable storage medium stores instructions which, when executed, cause a processing device to perform operations. The operations include receiving first data indicative of a processing recipe. The operations further include receiving second data. The second data includes operational data associated with the processing recipe. The operations further include receiving third data. The third data includes historical data associated with the processing recipe. The operations further include performing analysis indicative of performance of a manufacturing system. The analysis is based on the first, second, and third data. The operations further include causing performance of a corrective action in view of the analysis.

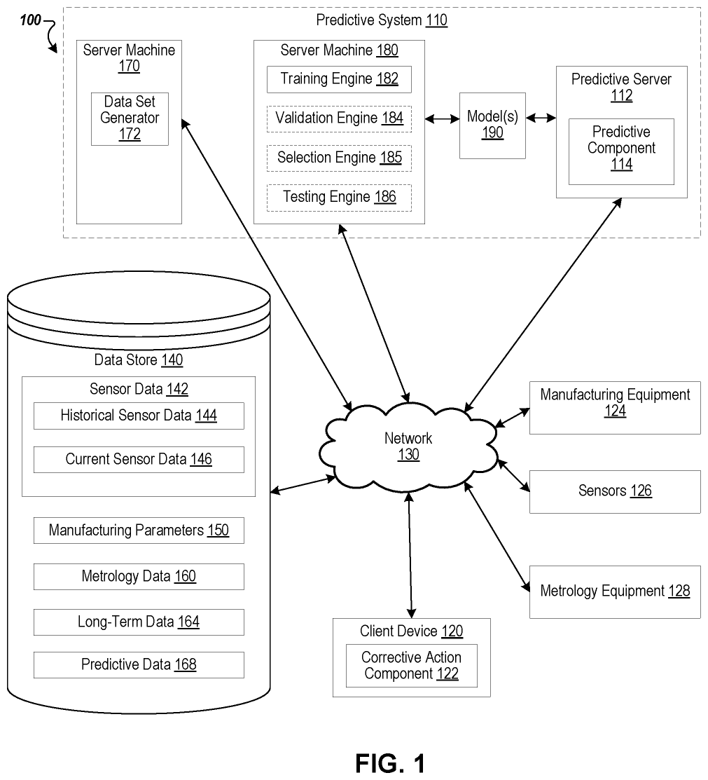

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data 144 and current sensor data 146. Current sensor data 146 may be associated with a product currently being processed, a product recently processed, a number of recently processed products, etc. Current sensor data 146 may be used as input to a trained machine learning model, e.g., to generate predictive data 168. Historical sensor data 144 may include data stored associated with previously produced products. Historical sensor data 144 may be used to train a machine learning model, e.g., model 190.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Data associated with some hardware parameters and/or process parameters may, instead or additionally, be stored as manufacturing parameters 150. Manufacturing parameters 150 may include historical manufacturing parameters (e.g., associated with historical processing runs) and current manufacturing parameters. Manufacturing parameters 150 may be indicative of input settings to the manufacturing device (e.g., heater power, gas flow, etc.). Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates may have property values (film thickness, film strain, etc.) measured by metrology equipment 128, e.g., measured at a standalone metrology facility. Metrology data 160 may be a component of data store 140. Metrology data 160 may include historical metrology data 164 (e.g., metrology data associated with previously processed products). Manufacturing parameters 150 may include data recipe data. Recipe data may include set points associated with substrate processing. Recipe data may include target temperatures, gas compositions, gas pressure, RF power, or any other parameter that may be included in a process recipe. Recipe data of manufacturing parameters 150 may include time stamps to achieve a target property value, time stamps to perform one or more actions, or the like. Manufacturing parameters 150 may include instructions for manufacturing equipment 124 to perform processing operations.

Manufacturing parameters 150 may include equipment constant data. Equipment constants may be data associated with a process chamber, a process tool, etc. Equipment constants may enable a process chamber to perform recipe operations. For example, equipment constants may include instructions for valve opening to enable a gas flow. Equipment constants may include instructions for providing a current to a heater to achieve a target temperature. Equipment constants may include a threshold pressure level to consider a chamber to be evacuated, vented, pressurized, etc.

Metrology data 160 includes data associated with properties of processed substrates. Metrology data 160 may be collected by metrology equipment 128. Metrology equipment 128 may include standalone metrology equipment, e.g., metrology equipment physically separate from the processing tool. In some embodiments, a subset of substrates processed by a processing tool may be sent to a standalone metrology facility. A comprehensive analysis module may recommend one or more substrates for standalone metrology. A comprehensive analysis module may recommend one or more substrates for metrology based on trace data, recipe data, equipment constant data, etc.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data (e.g., metrology data associated with a product currently or recently processed).

In some embodiments, sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). Sensor data 142 may include features and the features may be used by predictive component 114 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

Long-term data 164 includes data associated with processing of many substrates. Long-term data 164 may be used by a comprehensive analysis module to determine whether performance of a processing tool is changing over time. Long-term data 164 may be utilized to determine whether one or more components are drifting, aging, failing, etc. Long-term data 164 may be utilized to recommend corrective actions. Corrective actions may include preventative maintenance, corrective maintenance, component replacement, chamber seasoning, or the like. Long-term data 164 may be utilized for process control. Long-term data 164 may be utilized for statistical process control. Long-term data 164 may be utilized for fault detection. Long-term data 164 may be utilized for fault classification.

In some embodiments, predictive system 110 may generate predictive data 168. Predictive data 168 may include recommended corrective actions. Predictive data 168 may include predictions of root causes of faults, drift, or the like. Predictive data 168 may be generated responsive to receiving output from a comprehensive analysis module. Predictive data 168 may be generated by receiving output from one or more machine learning models. Predictive data 168 may be generated using supervised machine learning (e.g., predictive data 168 includes output from a machine learning model that was trained using labeled training data). For example, a supervised machine learning model may receive as training input sensor data labeled with metrology data as target output. In some embodiments, predictive system 110 may generate predictive data 168 using unsupervised machine learning. Unsupervised machine learning models may be trained using unlabeled data. Output of an unsupervised machine learning model may include clustering results, principle component analysis, anomaly detection, etc. In some embodiments, predictive system 110 may generate predictive data 168 using semi-supervised learning (e.g., training data may include a mix of labeled and unlabeled data).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110.

In some embodiments, corrective action component 122 receives an indication of a corrective action from the predictive system 110 and causes the corrective action to be implemented. Each client device 120 may include an operating system that allows users to one or more of generate, view, or edit data. Client device 120 may provide a user interface. Client device 120 may present data provided by predictive system 110 to a user via the user interface. Client device 120 may present data provided by a comprehensive analysis module to a user via the user interface. Predictive system 110 may implement a comprehensive analysis module (e.g., via predictive server 112 and models 190). Client device 120 may present data associated with manufacturing equipment 124. Client device 120 may present recommended corrective actions associated with manufacturing equipment 124.

In some embodiments, metrology data 160 corresponds to historical property data of products. Metrology data 160 may correspond to products processed using manufacturing parameters associated with historical sensor data 144. Predictive data 168 may be associated with predicted property data of products. Predictive data 168 may be associated with predicted properties of products to be produced. Predictive data 168 may be associated with predicted properties of products that have been produced in conditions recorded by current sensor data 146. Predictive data 168 may be associated with predicted properties of products that have been produced in conditions associated with a set of manufacturing parameters 150.

In some embodiments, predictive data 168 is or includes predicted metrology data of products to be produced. Predictive data 168 may include predicted metrology data of products that have been produced according to conditions recorded as current sensor data 146. In some embodiments, predictive data 168 is or includes an indication of any abnormalities (e.g., abnormal products, abnormal components, abnormal manufacturing equipment 124, abnormal energy usage, etc.). Predictive data 168 may include one or more causes of abnormalities. In some embodiments, predictive data 168 is an indication of change over time or drift in some component of manufacturing equipment 124, sensors 126, metrology equipment 128, or the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control.

Performing manufacturing processes that result in defective products can be costly in time, energy, products, components, manufacturing equipment 124, the cost of identifying the defects and discarding the defective product, etc. By inputting sensor data 142 and/or manufacturing parameters 150 into predictive system 110, receiving output of predictive data 168, and performing a corrective action based on the predictive data 168, system 100 can have the technical advantage of avoiding the cost of producing, identifying, and discarding defective products. By providing Long-term data 164 to predictive system 110, obtaining predictive data 168, and performing a corrective action based on predictive data 168, system 100 can have the technical advantage of avoiding costs of defective products.

Performing manufacturing processes that result in failure of the components of the manufacturing equipment 124 can be costly in downtime, damage to products, damage to equipment, express ordering replacement components, etc. By inputting sensor data 142, metrology data 160, long-term data 164, etc., receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Corrective actions may include maintenance, component replacement, replacement cleaning, chamber seasoning, recipe updating, BKM updating, etc. Monitoring the performance over time of components, e.g. manufacturing equipment 124, sensors 126, metrology equipment 128, and the like, may provide indications of degrading components.

Manufacturing parameters may be suboptimal for producing products. Suboptimal manufacturing parameters may have costly results of increased resource (e.g., energy, coolant, gases, etc.) consumption, increased amount of time to produce the products, increased component failure, increased amounts of defective products, etc. By inputting data to predictive system 110 (e.g., a comprehensive analysis module), receiving an output of predictive data 168, and performing a corrective action based on predictive data 168, system 100 can have the technical advantage of using optimal manufacturing parameters to avoid costly results of suboptimal manufacturing parameters.

Manufacturing processes may have a greater environment impact than expected. Some combinations of recipe parameters, hardware parameters, etc., may cause increased environmental impact due to increased greenhouse gas production, increased energy usage, increased material waste, etc. By inputting data into predictive system 110 (e.g., a comprehensive analysis module), receiving predictive data 168, and performing a corrective action based on predictive data 168, system 100 may have the technical advantage of reducing environmental impact of processing operations.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert. An alert may include an alarm to stop or not perform the manufacturing process. An alert may be triggered if the predictive data 168 indicates a predicted abnormality, such as an abnormality of the product, a component, or manufacturing equipment 124. In some embodiments, a machine learning model is trained to monitor the progress of a processing run as part of a comprehensive analysis module. A machine learning model may be trained to monitor in-situ sensor data to predict if a manufacturing process has reached completion. In some embodiments, the machine learning model may send instructions to end a processing run when the model determines that the process is complete. In some embodiments, the corrective action includes providing feedback control. Feedback control may include modifying a manufacturing parameter responsive to the predictive data 168 indicating a predicted abnormality. In some embodiments, performance of the corrective action includes causing updates to one or more manufacturing parameters. In some embodiments performance of a corrective action may include retraining a machine learning model associated with manufacturing equipment 124. In some embodiments, performance of a corrective action may include training a new machine learning model associated with manufacturing equipment 124.

Manufacturing parameters 150 may include hardware parameters. Hardware parameters may include information indicative of which components are installed in manufacturing equipment 124, indicative of component replacements, indicative of component age, indicative of software version or updates, etc. Manufacturing parameters 150 may include process parameters. Process parameters may include temperature, pressure, flow, rate, electrical current, voltage, gas flow, lift speed, etc. In some embodiments, the corrective action includes causing or scheduling preventative operative maintenance. Preventative maintenance may include recommendations to replace, process, clean, etc. components of the manufacturing equipment 124. In some embodiments, the corrective action includes causing design optimization, such as updating manufacturing parameters, manufacturing processes, manufacturing equipment 124, etc. for an optimized product. In some embodiments, the corrective action includes a updating a recipe. Updating a recipe may include altering the timing of manufacturing subsystems entering an idle or active mode, altering set points of various property values, etc.

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current sensor data 146, current manufacturing parameters, metrology data 160, and/or long term data 164 and generate output for performance of a corrective action. Predictive component 114 may obtain data by receiving data from the client device 120, retrieve data from the data store 140, or the like. Predictive component 114 may generate predictive data 168 as output. Predictive component 114 may implement a comprehensive analysis module. Corrective actions may be associated with manufacturing equipment 124, sensors 126, and/or metrology equipment 128. In some embodiments, predictive data 168 may include one or more predicted dimension measurements of a processed product. Predictive data 168 may include predicted metrology of a product. Predictive component 114 may use one or more models, rules, statistical metrics, heuristic models, or the like to generate output. In some embodiments, predictive component 114 may use one or more trained machine learning models 190 to determine the output for performing the corrective action based on current data.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126), manufacturing parameters 150 (e.g., associated with process control of manufacturing equipment 124), metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives current sensor data 146, current metrology data 166 and/or current manufacturing parameters 154, performs signal processing to break down the current data into sets of current data, provides the sets of current data as input to a trained model 190, and obtains outputs indicative of predictive data 168 from the trained model 190. In some embodiments, predictive component 114 receives metrology data (e.g., predicted metrology data based on sensor data) of a substrate and provides the metrology data to trained model 190. For example, current sensor data 146 may include sensor data indicative of metrology (e.g., geometry) of a substrate.

In some embodiments, the various models discussed in connection with model 190 (e.g., supervised machine learning model, unsupervised machine learning model, etc.) may be combined in one model (e.g., an ensemble model), or may be separate models. Various models, including heuristic models, rule-based models, machine learning models, statistical models, etc., may be included in a comprehensive analysis module.

Data may be passed back and forth between several distinct models included in model 190, predictive component 114, etc. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, long-term data 164, and predictive data 168.

Sensor data 142 may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features, e.g., historical metrology data and current metrology data. Historical sensor data, historical metrology data, and historical manufacturing parameters may be historical data (e.g., at least a portion of these data may be used for training model 190). Current sensor data 146 and current metrology data may be current data (e.g., at least a portion to be input into learning model 190, subsequent to the historical data) for which predictive data 168 is to be generated (e.g., for performing corrective actions).

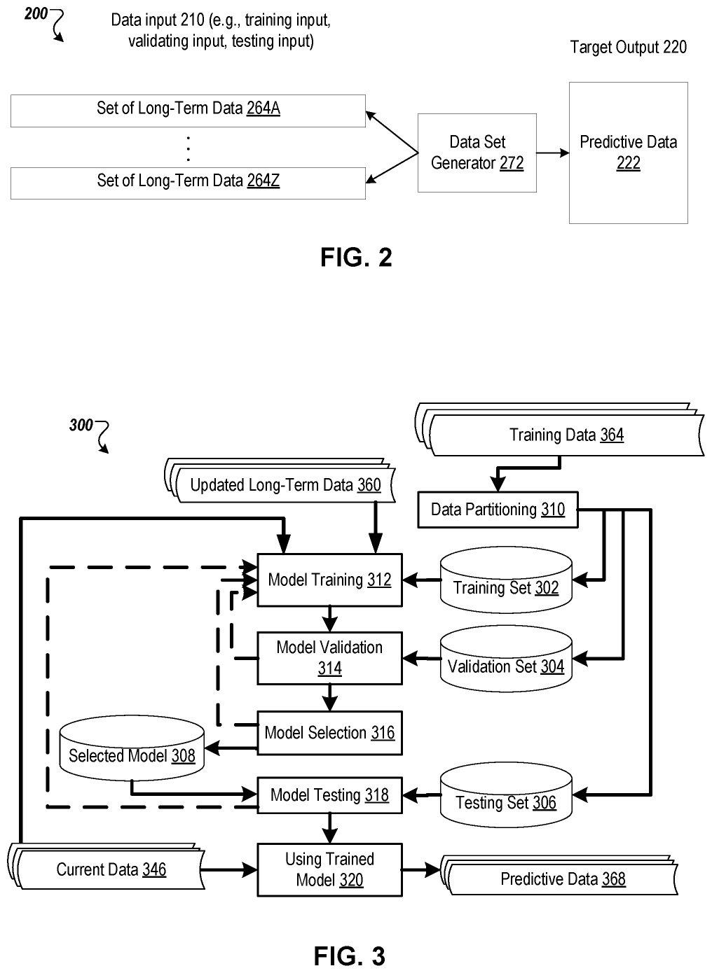

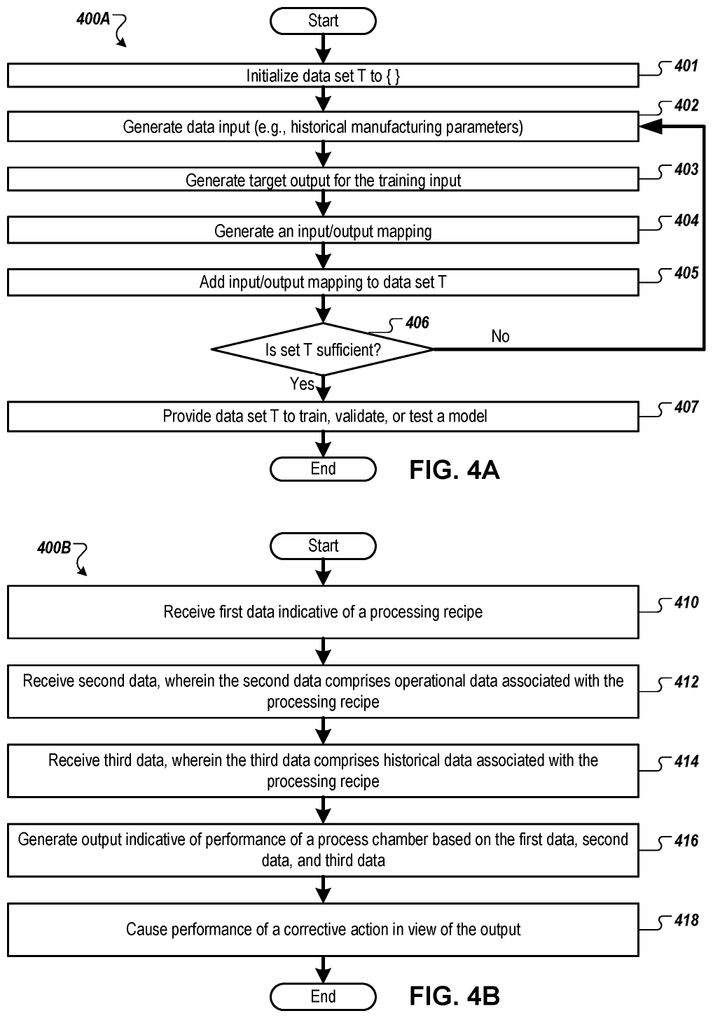

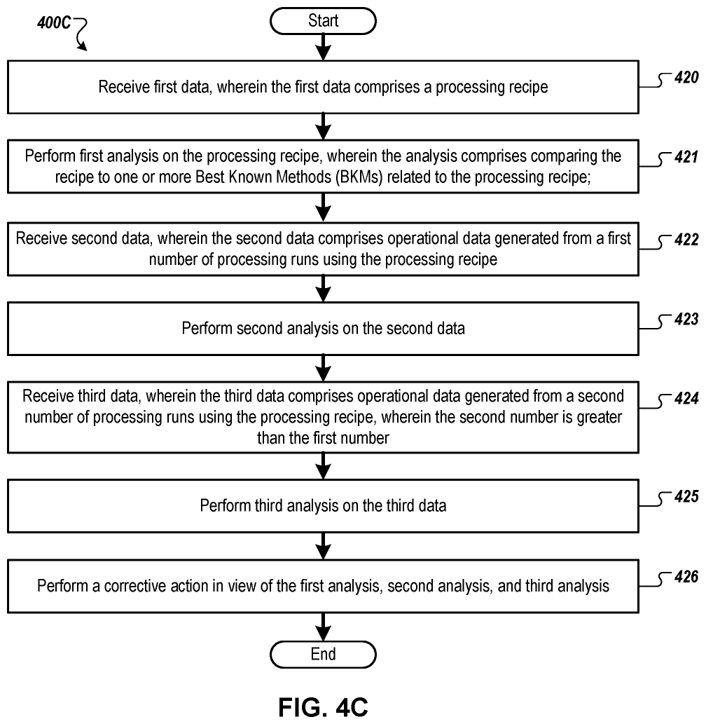

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition the historical data into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors). Data of the first set of features may include data that corresponds to each of the data sets (e.g., training set, validation set, and testing set). A second set of features may correspond to a second set of types of sensor data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive output of a first model and use that output as training input for a second model.

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Predictive component 114 may provide current data to model 190 and may run model 190 on the input to obtain one or more outputs. For example, predictive component 114 may provide current sensor data 146 to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data.

For purpose of illustration, rather than limitation, aspects of the disclosure describe the training of one or more machine learning models 190 using historical data and inputting current data into the one or more trained machine learning models to determine predictive data 168. In other embodiments, a heuristic model, physics-based model, statistical model, or rule-based model is used to determine predictive data 168 (e.g., without using a trained machine learning model). In some embodiments, such models may be trained using historical data. In some embodiments, these models may be retrained utilizing historical data. Predictive component 114 may monitor historical sensor data 144, historical manufacturing parameters, and metrology data 160. Any of the information described with respect to data inputs 210A of FIG. 2 may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, process control, or the like.

FIG. 2 depicts a block diagram of an example data set generators 272 (e.g., data set generator 172 of FIG. 1). Data set generator 272 may be used to create data sets for training, testing, validating, etc. a model (e.g., model 190 of FIG. 1). Data set generator 272 may be used to create data sets for a machine learning model. Data set generator 272 may be used to create data sets for a physics-based model, a statistical model, or the like. Data set generator 272 may be used to generate data sets to select, validate, and/or test rules of a rule-based model. A comprehensive analysis module may include multiple data set generators. Each data set generator 272 may be part of server machine 170 of FIG. 1. In some embodiments, several machine learning models associated with manufacturing equipment 124 may be trained, used, and maintained (e.g., within a manufacturing facility). Each machine learning model may be associated with one data set generator 272, multiple machine learning models may share a data set generator 272, etc.

FIG. 2 depicts a system 200 including data set generator 272 for creating data sets for one or more supervised models. Data set generator 272 may create data sets (e.g., data input 210, target output 220) using historical data. In some embodiments, a data set generator similar to data set generator 272 may be utilized to train an unsupervised machine learning model, e.g., target output 220 may not be generated by data set generator 272. An unsupervised model may be used for anomaly detection, outlier detection, results clustering, or the like. A supervised model may be used to generate an association between input and output data, such as using patterns in long-term data to generate predictive data indicative of a recommended corrective action.

Data set generator 272 may generate data sets to train, test, and validate a model. In some embodiments, data set generator 272 may generate data sets for a machine learning model. In some embodiments, data set generator 272 may generate data sets for training, testing, and/or validating a model configured to generate predictive data 222. The machine learning model is provided with set of long-term data 264A as data input 210. In some embodiments, different data may be generate as data input 210, according to a target application for a model associated with the data sets. Data input 210 may include recipe data, manufacturing parameter data, manufacturing hardware data, sensor data, metrology data, etc.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data input 210 may include one or more sets of data. As an example, system 200 may produce sets of sensor data that may include one or more of sensor data from one or more types of sensors, combinations of sensor data from one or more types of sensors, patterns from sensor data from one or more types of sensors, etc.

In some embodiments, data set generator 272 may generate a first data input corresponding to a first set of long-term data 264A to train, validate, or test a first machine learning model. Data set generator 272 may generate a second data input corresponding to a second set of historical long-term data 264Z to train, validate, or test a second machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220.

In some embodiments, data set generator 272 may generate data sets for a machine learning model configured to perform fault detection classification. A fault detection classification model may be trained using historical data (e.g., long-term data). The fault detection classification model may be configured to receive current data and determine whether the current data indicates abnormal behavior. The fault detection classification model may compare current data to historical data. The fault detection classification model may compare historical sensor data to current sensor data. The fault detection classification model may detect changes in a manufacturing procedure that would not be detected by other methods, such as statistical metrics. For example, a fault detection classification model may be sensitive to time shifts, ramp rates, etc., that may be unobservable in overall statistics.

In some embodiments, data set generator 272 may generate data sets for a machine learning model configured to perform anomaly detection. An anomaly detection model may be an unsupervised model. Data set generator 272 may not generated target output 220 to train, test, or validate an unsupervised anomaly detection model. Changes in current data compared to historical data, or trends over long-term data, may be detected by an anomaly detection model. Anomalies in data from a pre-processing stage (e.g., recipe data, hardware parameter data, equipment constant data) may be detected using an anomaly detection model. Anomalies in data from a processing stage (e.g., trace data associated with processing a substrate) may be detected using an anomaly detection model. Anomalies in data over many processing procedures (e.g., long-term data) may be detected using an anomaly detection model.

Data inputs 210 may also be referred to as “features,” “attributes,” or “information.” In some embodiments, data set generator 272 may provide the data set to training engine 182, validating engine 184, or testing engine 186, where the data set is used to train, validate, or test a machine learning model.

Data inputs 210 to train, validate, or test a machine learning model may include information for a particular manufacturing chamber (e.g., for particular substrate manufacturing equipment). Target output 220 may similarly include information associated with a particular manufacturing chamber. In some embodiments, data inputs 210 may include information for a specific type of manufacturing equipment, e.g., manufacturing equipment sharing specific characteristics. Data inputs 210 may include data associated with a device of a certain type, e.g., intended function, design, produced with a particular recipe, etc. Target output 220 may be similarly associated with similar groups of data. Training a machine learning model based on a type of equipment, device, recipe, etc. may allow the trained model to generate plausible output in a number of settings (e.g., for a number of different facilities, products, etc.).

In some embodiments, subsequent to generating a data set and training, validating, or testing a machine learning model using the data set, the model may be further trained, validated, or tested, or adjusted. Adjusting a model may include adjusting weights or parameters associated with input data of the model, such as connection weights in a neural network.

FIG. 3 is a block diagram illustrating system 300 for generating output data (e.g., predictive data 168 of FIG. 1), according to some embodiments. In some embodiments, system 300 may be used in conjunction with a machine learning model configured to generate predictive data. In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to cluster or classify substrates. System 300 may be used in conjunction with a machine learning model with a different function than those listed, associated with a manufacturing system. System 300 may be used with another model for training, testing, and using the model, such as a statistical model or physics-based model.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training data 364 includes historical data, such as historical metrology data, historical classification data (e.g., classification of whether a product meets performance thresholds), historical microscopy image data, long-term data, etc. Training data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training data 364 includes sensor data, including features derived from sensor data from 20 sensors (e.g., sensors 126 of FIGS. 1) and 10 manufacturing parameters (e.g., manufacturing parameters that correspond to the same processing runs(s) as the sensor data from the 20 sensors), the sensor data may be divided into a first set of features including sensors 1-10 and a second set of features including sensors 11-20. The manufacturing parameters may also be divided into sets. For instance, manufacturing parameters may be divided into a first set of manufacturing parameters including parameters 1-5, and a second set of manufacturing parameters including parameters 6-10. Either training input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner. Supervised learning involves providing a training dataset including labeled inputs to the model, observing its outputs, defining an error (by measuring the difference between the outputs and the label values), and using techniques such as gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item to generate an output. The output may include predictive data. The output may include recommended corrective actions. The output may include recommended further investigations. The output may include fault detection classification. The output may be compared to a label of the training data item (e.g., a correct classification, corrective action, or the like).

Processing logic may then compare the generated output (e.g., recommended corrective action) to the label (e.g., an effective corrective action to correct a fault) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensors 1-10, metrology measurements 1-10, etc.). System 300 may generate a second trained model using the second set of features in the training set (e.g., sensor data from sensors 11-20, metrology measurements 11-20, etc.). In some embodiments, the first trained model and the second trained model may be combined to generate a third trained model (e.g., which may be a better predictor than the first or the second trained model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensors 1-10 or metrology measurements 1-10) and the second trained model using the second set of features in the validation set (e.g., sensor data from sensors 11-20 or metrology measurements 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensors 1-10), the first trained model to determine the first trained model meets a threshold accuracy (e.g., based on the first set of features of the testing set 306). Responsive to accuracy of the selected model 308 not meeting the threshold accuracy, flow continues to block 312 where system 300 performs model training (e.g., retraining) using different training sets corresponding to different sets of features (e.g., sensor data from different sensors). Accuracy of the selected model may not meet a threshold accuracy due to the selected model being overly fit to the training and/or validation set. Accuracy of the selected model 308 may not meet a threshold accuracy due to the selected model 308 not being applicable to other data sets, such as testing set 306. Responsive to determining that selected model 308 has an accuracy that meets a threshold accuracy based on testing set 306, flow continues to block 320. In at least block 312, the model may learn patterns in the training data to make predictions, and in block 318, the system 300 may apply the model on the remaining data (e.g., testing set 306) to test the predictions.

At block 320, system 300 uses the trained model (e.g., selected model 308) to receive current data 346 (e.g., current sensor data) and determines (e.g., extracts), from the output of the trained model, predictive data 368. A corrective action associated with the manufacturing equipment 124 of FIG. 1 may be performed in view of predictive data 368. In some embodiments, current data 346 may correspond to the same types of features in the historical data used to train the machine learning model. In some embodiments, current data 346 corresponds to a subset of the types of features in historical data that are used to train selected model 308 (e.g., a machine learning model may be trained using a number of metrology measurements, and configured to generate output based on a subset of metrology measurements).

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Updating a machine learning model may be performed by providing additional data to a training engine. Updated long-term data 360 may be provided to a training engine, instead of or in addition to training data 364. Updated long-term data 360 may include additional data collected from substrate processing operations performed subsequent to training of the machine learning model to be updated.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be done, utilizing current data 346 and/or updated long-term data 360.

FIGS. 4A-C are flow diagrams of methods 400A-C associated aspects of the present disclosure, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by predictive system 110. Method 400A may be performed, in part, by predictive system 110 (e.g., server machine 170 and data set generator 172 of FIG. 1, data set generators 272A-B of FIGS. 2A-B). Predictive system 110 may use method 400A to generate a data set to at least one of train, validate, or test a machine learning model, in accordance with embodiments of the disclosure. Methods 400B-C may be performed by predictive server 112 (e.g., predictive component 114) and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of sensor, manufacturing parameters, metrology data, etc. In some embodiments, the first data input may include a first set of features for types of data and a second data input may include a second set of features for types of data (e.g., as described with respect to FIG. 3). Input data may include historical data and/or synthetic data in some embodiments.

In some embodiments, at block 403, processing logic optionally generates a first target output for one or more of the data inputs (e.g., first data input). In some embodiments, the input includes sensor data and the output includes anomaly detection. In some embodiments, the input includes long-term data and the output includes fault detection classification. In some embodiments, the input includes long-term data and/or sensor data and output includes one or more recommended corrective actions. In some embodiments, input data is in the form of sensor data and target output is a list of components likely to be faulty, as in the case of a machine learning model configured to identify failing manufacturing systems. In some embodiments, no target output is generated (e.g., an unsupervised machine learning model capable of grouping or finding correlations in input data, rather than requiring target output to be provided).

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, or for performing a corrective action associated with manufacturing equipment 124.

FIG. 4B is a flow diagram of a method 400B for using a comprehensive analysis module for performing a corrective action, according to some embodiments. At block 410, processing logic receives first data indicative of a processing recipe. The first data may include recipe steps. The first data may be generated, received by the processing device, etc., before any substrates are processed using the recipe. The first data may be data associated with a pre-processing stage of manufacturing. Other data associated with pre-processing stage of manufacturing may further be provided to the processing device. Other data from the pre-processing stage of manufacturing may include equipment constants of a tool or chamber, manufacturing parameters, target substrate properties, etc.

At block 412, processing logic receives second data. The second data comprises operational data associated with the processing recipe. The second data may be associated with the processing stage of manufacturing. The second data may be associated with one or more specific processing procedures, operations, or the like. The second data may be sensor data. The second data may be trace data. The second data may be data collected from a process chamber while the chamber enacts the processing recipe.

At block 414, processing logic receives third data. Third data comprises historical data associated with the process recipe. Third data may include data from a number of processed substrates. Third data may include data from a large number of processed substrates, substrates processed over a large span of time, etc. Third data may be long-term data. Third data may be similar to the second data, e.g., may include time trace data. Third data may be different than the second data, e.g., may include statistical metrics, compressed data, summary data, or the like. Third data may include substrate metrology data, substrate performance data, etc.

At block 416, processing logic generates output indicative of performance of a process chamber based on the first data, second data, and third data. Generating output may include providing data to a comprehensive analysis module. Generating output may include providing data to one or more models. Generating output may include providing data to one or more machine learning models, one or more rule-based models, one or more statistical models, one or more physical models, etc.

Generating output may include comparing data to one or more BKMs. First data may be compared to BKMs. Recipe data may be compared to BKMs (e.g., recipe checking). Equipment constants may be compared to BKMs (e.g., equipment constant monitoring). Hardware parameters may be compared to BKMs. Generating output may include comparing first data to a plurality of rules associated with processing recipes. Comparing of first data to rules may be performed before the processing recipe is used to process a substrate.

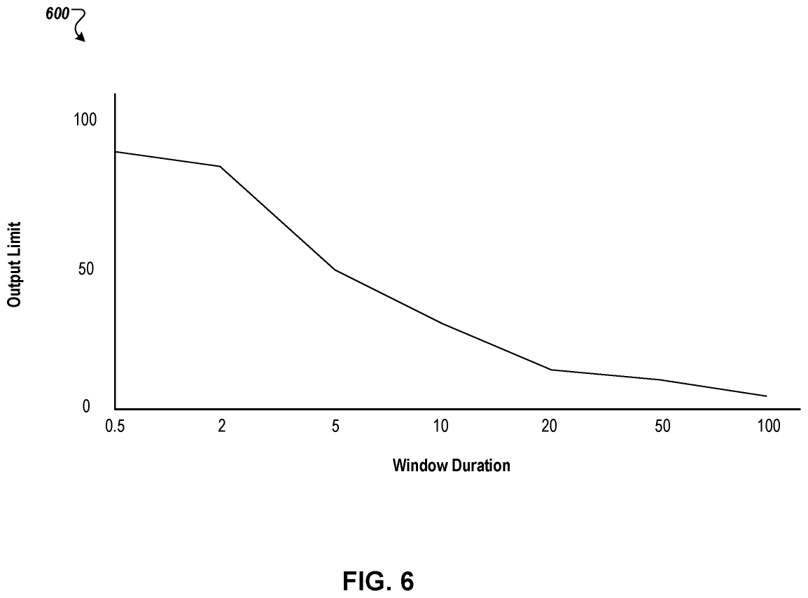

Generating output may include performing operating window analysis. Operating window analysis includes performing statistical analysis of data points within one or more time windows. The one or more time windows may be of different durations. The statistical analyses may be compared to threshold values. Whether or not one or more statistical metrics satisfies one or more threshold conditions may be used in determining whether or not to recommend a corrective action, what corrective action to recommend, etc. Operating window analysis is described in greater detail in connection with FIG. 6.

Generating output may include performing one or more tests upon the second data. Tests may be performed after a substrate has been processed using the processing recipe. Tests may be performed after a first number of substrates have been processed using the processing recipe. Tests may include comparing trace data to historical trace data, comparing other manufacturing data to historical data, etc.

Generating output may include performing one or more tests upon the third data. The third data may be associated with processing a large number of substrates (e.g., associated with more substrates than the second data). Testing third data may include providing third data to a statistical model. Testing third data may include providing third data to a machine learning model. Testing third data may include checking third data for outliers. Testing third data may include checking statistical metrics associated with substrate processing, e.g., for statistical process control. Testing third data may include checking data for variations, anomalies, and/or drifting, e.g., for fault detection classification.

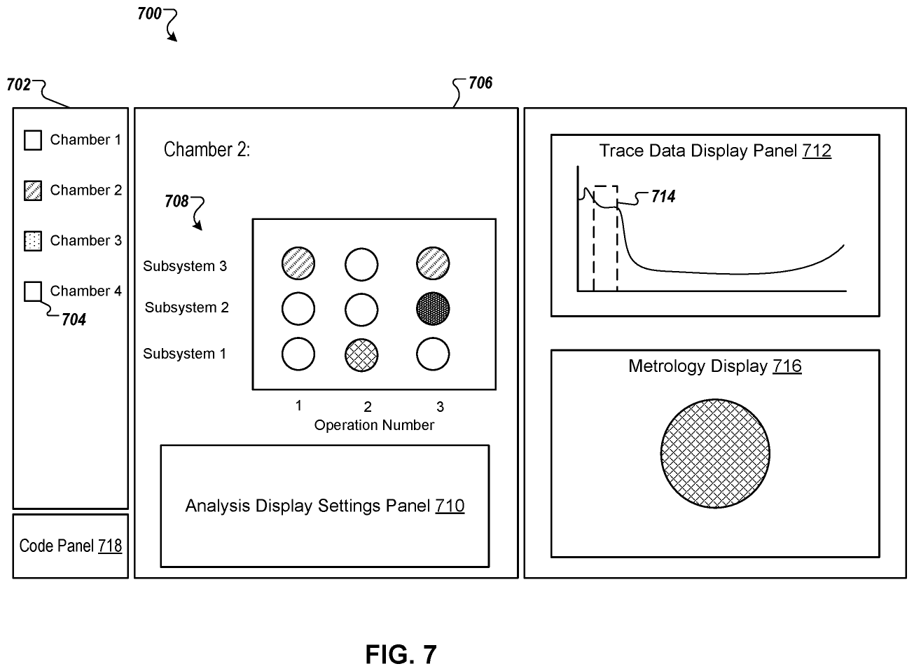

At block 418, processing logic causes performance of a corrective action in view of the generated output. Causing performance of a corrective action may include providing an alert to a user. Causing performance of a corrective action may include displaying a visual representation on a user interface. Causing performance of a corrective action may include displaying a visual representation of first data. Causing performance of a corrective action may include displaying a visual representation of second data. Causing performance of a corrective action may include displaying a visual representation of third data. Causing performance of a corrective action may include displaying a visual representation of the output. Causing performance of a corrective action may include generating a code identifying anomalous process chamber behavior. A code may be a visual code, such as a bar code, QR code, or the like. The code may be used to enable a user to quickly view a visual representation of anomalous behavior. The code may be used to enable a user to quickly view a visual representation of chamber performance. Additional description of an example user interface is found in connection with FIG. 7.

In some embodiments, one or more operations of method 400B may not be performed. A corrective action may be performed based on a subset of the first data, second data, and third data. Responsive to reception of recipe data by a comprehensive analysis module, a corrective action may be performed before generation of operational data. Recipe checking operations may recommend one or more recipe updates, e.g., before the recipe is run. Responsive to reception of operational data by the comprehensive analysis module, a corrective action may be performed before accumulating long-term (e.g., historical) data. One or more corrective actions may be performed based on operational data of a small number of substrate processing procedures. Corrective actions may be performed and/or recommended based on analysis of any combination of first data (e.g., pre-processing stage data), second data (e.g., operational data, processing stage data) and third data (e.g., historical data, long-term stage data).

FIG. 4C is a flow diagram of a method 400C for utilizing a comprehensive analysis module for performance of a corrective action, according to some embodiments. At block 420, processing logic receives first data, wherein the first data comprises a processing recipe. At block 421, processing logic performs first analysis on the processing recipe. The analysis includes comparing the recipe to one or more BKMs related to the processing recipe. The analysis on the processing recipe may be performed before the processing recipe is used, e.g., before a substrate is processed according to the processing recipe. The first analysis may be performed by providing the first data to a comprehensive analysis module. The first analysis may be performed by providing the first data to one or more models.

At block 422, processing logic receives second data. The second data comprises operational data generated from a first number of processing runs using the processing recipe. Operational data may include sensor data. Operational data may include data related to processing conditions, such as temperature, pressure, RF power, etc. Operational data may include data related to substrate processing, such as in-chamber metrology data, metrology proxies, etc. At block 423 processing logic performs second analysis on the second data. Performing the second analysis may include providing the second data to a comprehensive analysis module. Performing the second analysis may include providing the second data to one or more models. Performing the second analysis may include providing the second data to one or more machine learning models.

At block 424, processing logic receives third data. The third data comprises operational data generated form a second number of processing runs using the processing recipe. The operational data may include sensor data, manufacturing data, etc. The operational data may include processed data, such as summarized sensor data, statistical metrics associated with the sensor data, simplified sensor data, etc. The second number of processing runs is greater than the first number of processing runs. The third data may monitor performance of a process chamber over the course of many processing runs. In some embodiments, the third data may correspond to data collected over a longer span of time than the second data. The third data may correspond to a subset of substrates processed over the longer span of time, e.g., may be fewer than the substrates of the second data in some embodiments. The third data may comprise long-term data.

At block 425, processing logic performs third analysis on the third data. Third analysis may include providing third data to a comprehensive analysis module. Third analysis may include providing third data to one or more models. Third analysis may include providing third data to one or more machine learning models. Third analysis may include statistical process control analysis, fault detection classification, etc.

At block 426, processing logic causes performance of a corrective action in view of the first analysis, second analysis, and third analysis. The corrective action may include providing an alert to a user. The corrective action may include displaying the alert on a graphical user interface. The corrective action may include updating an aspect of a processing procedure, such as a processing recipe, one or more equipment constants, or the like. The corrective action may include scheduling maintenance, such as corrective maintenance, preventative maintenance, chamber seasoning, replacement of one or more components, etc. The corrective action may include updating the comprehensive analysis module, such as retraining one or more models, updating one or more BKMs, etc.

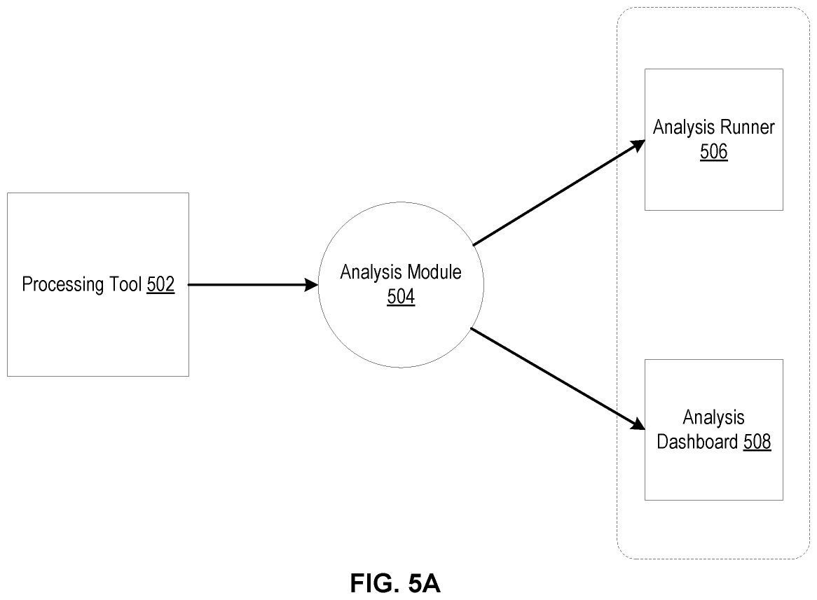

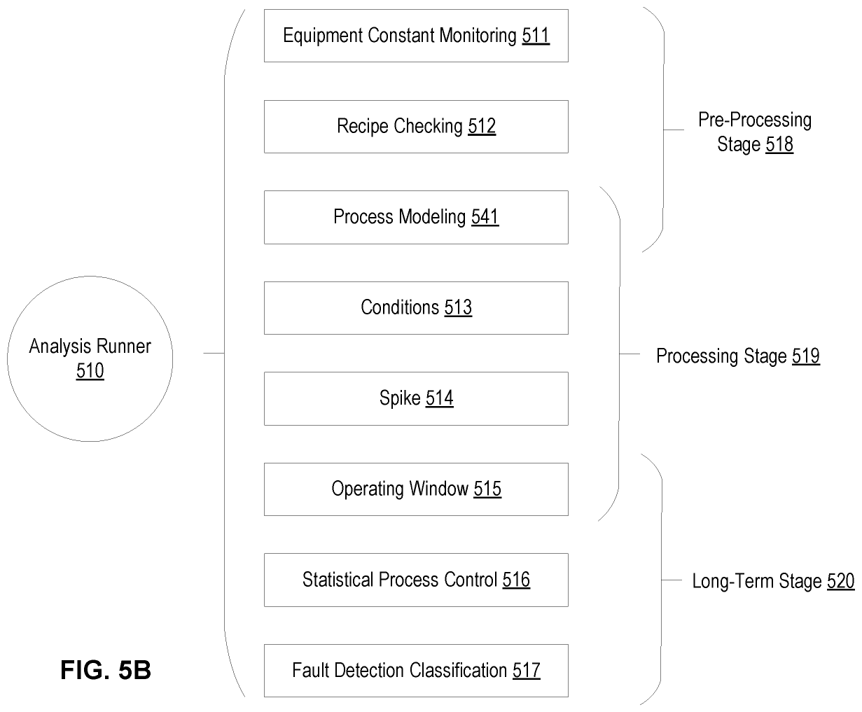

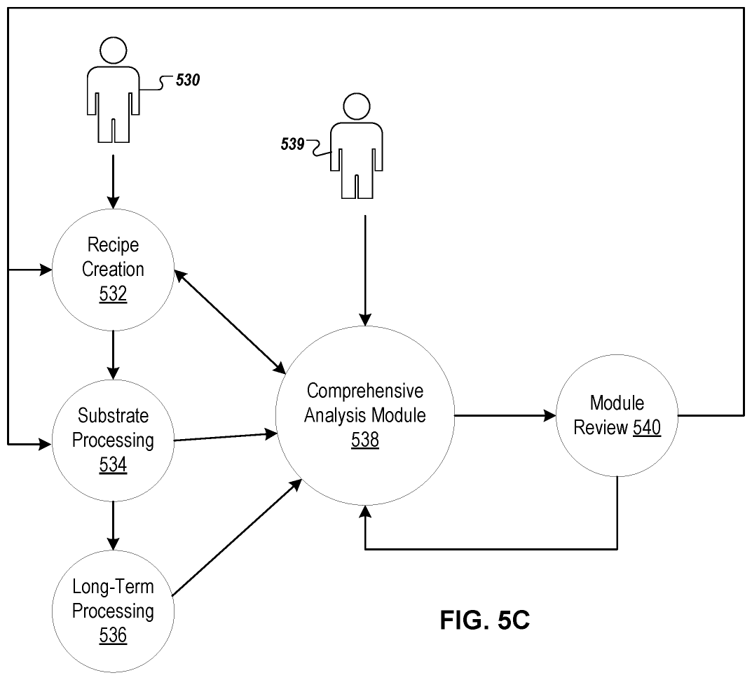

FIG. 5A depicts a flow of data through an automated comprehensive analysis module, according to some embodiments. Data may be received by the comprehensive analysis module 504 from a processing tool 502. Data may include recipe data, sensor data, hardware data, etc. Data may be automatically provided to analysis module 504 from processing tool 502. Data being automatically provided may indicate that a user does not choose data to provide to the analysis module 504. Data being automatically provided may indicate that a user does not perform an action to facilitate data transfer from processing tool 502 to analysis module 504, beyond initial set-up of the analysis module 504.

Analysis module 504 may perform tasks separable into two groups: data analysis and display. Data analysis tasks may be performed by analysis runner 506. Display tasks may be performed by analysis dashboard 508. Operations of analysis runner 506 and analysis dashboard 508 may interact with each other. For example, analysis dashboard 508 may display output generated by analysis runner 506, analysis runner 506 may perform tasks received by the analysis module 504 from a user via analysis dashboard 508, etc.

Analysis runner 506 may include one or more models to draw conclusions from processing tool data. Analysis runner 506 may include comparing data to one or more BKMs. Comparing data to BKMs may be simple rules checks, if/then checks, etc. Comparing data to BKMs may be statistical in nature, e.g., ensuring that an average sensor value is within a target threshold. Comparing data to BKMs may be performed by providing data to a trained machine learning model. Comparing data to BKMs may include operating window analysis. Analysis runner 506 may generate predictive data. Analysis runner 506 may generate predicted metrology data of a substrate. Analysis runner 506 may compare predicted metrology data to measured metrology data. Analysis runner 506 may generate one or more reports of tool, chamber, or component performance. Analysis runner 506 may generate one or more reports of tool, chamber, or component drift. Analysis runner 506 may generate one or more reports of fleet performance, fleet outliers, or fleet drift. Analysis runner 506 may generate one or more reports of substrate performance, substrate anomalies, substrate outliers, etc. Analysis runner 506 may generate one or more reports of subsystem performance. Subsystems may include related components of a tool or chamber, such as a temperature control subsystem, gas delivery subsystem, RF delivery subsystem, or the like. Analysis runner 506 may generate one or more recommended corrective actions. Analysis runner 506 may implement one or more corrective actions. Corrective actions may include providing an alert to a user, recommended chamber maintenance, recommended recipe updates, recommended equipment constant updates, recommended BKM updates (for example, if a previously believed violation of best practices is contradicted by new data), etc.

Analysis dashboard 508 may include a user interface. Analysis dashboard 508 may display alerts to a user. Analysis dashboard 508 may accept commands from a user, such as commands to display results of an analysis, display one or more reports, request analysis runner 506 to perform additional analysis, etc. Any of the reports generated by analysis runner 506 may be displayed via analysis dashboard 508. Analysis dashboard 508 may display recommended corrective actions. Analysis dashboard 508 may display a visual indication of chamber health, fleet health, tool health, or the like.

FIG. 5B is a block diagram depicting various analysis categories included in a comprehensive analysis module, according to some embodiments. Analysis runner 510 of a comprehensive analysis module may be considered to treat data from three stages of substrate processing: pre-processing stage 518, processing stage 519, and long-term stage 520. Each stage of processing may correspond to one or more types of analysis included in analysis runner 510. Pre-processing stage 518 may include analysis that does not require substrate processing operational data, e.g., recipe checking. Processing stage 519 may include analysis dependent data from one or more substrate processing operations. Long-term stage 520 may include one or more analyses related to many substrate processing procedures, substrate processing procedures over a span of time, or the like. In some embodiments, the analysis module may be considered to look at data in three ways. The analysis module may be considered to analyze recipe data (e.g., data that may be examined before processing any substrates). The analysis module may be considered to analyze operating data (e.g., data that may be examined after processing one or a few substrates). The analysis module may be considered to analyze long-term data (e.g., data based on processing of many substrates that may be related to long-term drift of a processing chamber, historical data analysis, etc.). In some embodiments, the analysis module may determine violations of BKMs, anomalies, drift, operating window violations, etc. Upon determining faults, problems, or anomalous behavior, the analysis module may cause corrective actions, such as scheduling maintenance, scheduling software updates, updating processing recipes, scheduling metrology or other checks of products or equipment, etc.

Operation of analysis runner 510 associated with substrate pre-processing stage 518 may include equipment constant monitoring 511 and recipe checking 512.

Operations of analysis runner 510 associated with substrate pre-processing stage 518 may include process modeling 541. Equipment constant monitoring 511 includes checking settings and constants associated with a process tool. Equipment constants may include values, parameters, settings, or the like. Equipment constants may determine how the processing chamber controls hardware components. Equipment constants may determine how a processing chamber interprets recipe data. For example, equipment constants may control how much power is supplied to a heater to achieve a target temperature, how much an actuator is opened to achieve a target gas flow, how quickly a robot transfers a substrate, etc. A comprehensive analysis module may receive data indicative of equipment constants. The comprehensive analysis module may (e.g., via analysis runner 510) compare equipment constant data to a set of rules or criteria associated with BKMs. The analysis module may supply recommendations to update equipment constants which do not satisfy one or more rules or criteria. The analysis module may supply recommendations to update equipment constants which are not aligned with BKMs. The analysis module may supply recommended updates to BKMs.

In some embodiments, recipe checking 512 may include examining input recipes for violations of a second set of rules or criteria associated with BKMs. For example, it may be understood that two settings should not be applied concurrently, e.g., it may be difficult to change temperature and pressure in tandem, it may lead to inconsistent results to reduce gas flow below a certain value, etc. Recipe checking operations of the comprehensive analysis module may ensure that rules and criteria associated with such BKMs are not violated. Recipe checking and equipment constant monitoring may include if/then rules, e.g., rule-based analysis. Pre-processing stage 518 analysis may include single variable rules, such as if a target temperature exceeds a threshold value, the recipe is in violation of a BKM. Pre-processing stage 518 analysis may include multi-variable rules, such a rules indicating that if a first condition is met, a second condition should be monitored. If the first condition and the second condition are met, the parameters may be in violation of a BKM. Multi-variable rules may include more complicated relations, including a series of inter-related conditions. Threshold values of a first variable may depend upon measured or target values of a second variable, for example. Multi-variable rules may extend beyond a single process operation (e.g., step). Multi-variable rules may related to preceding or proceeding operations. Variable values of a first processing operation may affect threshold values of an earlier or later operation. Variable values of a first processing operations my determine whether or not a condition is checked in an earlier or later operation.

Process modeling 541 may be performed based on data from a pre-processing stage 541. Process modeling 541 includes providing data of the pre-processing stage 518 to one or more models, and receiving output from the models. The models may include statistical models. The models may include machine learning models. The model(s) of process modeling 541 may be configured to receive pre-processing stage 518 data as input and providing predictive data as output. Output of process modeling 541 may include an estimate of properties of a substrate processed in accordance with input data. Output of process modeling 541 may include predicted metrology of a substrate processed in accordance with input data. Output of process modeling 541 may include predicted performance of a substrate processed in accordance with input data. Output of process modeling 541 may include predicted risk of a resultant substrate including one or more target defects. Output of process modeling 541 may include predicted properties of a resultant substrate, such as thickness, critical dimension, refractive index, extinction coefficient, etc.

Operations associated with processing stage 519 may include process modeling 541, conditions 513 analysis, spike 514 analysis, and/or operating window 515 analysis. Process modeling 541 may be performed based on operating data of a manufacturing system. Process modeling 541 may be performed utilizing data associated with processing stage 519 as process input. Process modeling 541 utilizing process stage 519 data may include providing operational data such as sensor data to one or more models. Models may include statistical models, machine learning models, etc. Models of process modeling 541 may receive as input data of processing stage 519 and generate as output predictions of results associated with the input data. Models of process modeling 541 may generate predicted substrate properties based on input operational data, similar to output generated by process modeling 541 based on pre-processing stage 518 data.

Analysis associated with processing stage 519 may be based on operating data of a manufacturing system. Operating data may include sensor data, processing parameters, recipe set points, etc. Operating data may include data from sensors of components controlled by the processing system. For example, operating data may include sensors measuring actuator positions in the processing system. Operating data may include data from sensors that are not associated with components directly controlled by the processing system. For example, operating data may include sensors measuring temperature or pressure in the processing system. Condition checking 513 may share one or more features with recipe checking 512. Condition checking 513 may include rule-based analysis. Conditions checking 513 may verify that conditions within a process chamber or process tool are within an acceptable range. Conditions checking 513 may verify that sensor measurements satisfy one or more threshold conditions. For example, a sensor measurement being above or below a target value may be flagged by a comprehensive analysis module as an anomaly. Conditions checking 513 may be dependent upon other data, e.g., recipe data. Condition checking 513 may verify that sensor measurements are within a threshold window of target property values.

Spike 514 analysis may be used to detect spiking behavior in time trace sensor data. Spiking behavior (including positive and negative spikes) may be indicative of hardware failure, or particular physical conditions within a processing chamber, for example. For example, arcing may cause a spike in electrical energy. In some embodiments, simpler analysis methods (e.g., examining an average of a value over the course of a processing operation) may not reveal problematic behavior such as spiking. Spikes may be observed in reflected power, current supplied to components e.g. electrostatic chucks, etc. Spikes may be observed in any sensor monitoring processing conditions.

Operations associated with processing stage 519 may include operating window 515 analysis. In some embodiments, operating window 515 analysis may include ensuring that sensors are performing within operating limits. For example, a sensor may be known (e.g., via BKMs) to operate best when between 10% and 90% of its normal operating range (e.g., operating temperature). Operating window 515 analysis may check optimal operating windows of various components and compare them to sensor data. In some embodiments, operating window 515 analysis may ensure that controlled variables are not outside limits, e.g., ensure a valve is not 100% open, for example to protect the valve from damage, etc. In some embodiments, operating window 515 analysis may include a time-gated component, as described in more detail in connection with FIG. 6.

Comprehensive analysis may be performed by the comprehensive analysis module on data associated with a long-term stage 520 of processing, e.g., data collected over may processing runs. Long-term data analysis may indicate how a recipe, tool, chamber, fleet, etc., is performing over time. Long-term data analysis may include Statistical Process Control (SPC) 516. Statistical Process Control 516 may include using statistical metrics of data associated with substrate processing to analyze performance over time. For example, SPC 516 may include taking the average of temperature, pressure, etc., recorded by a sensor over a processing operation, and comparing it to historical data of the same sensor. In some embodiments, SPC 516 methods may compare many processing runs, e.g., tens or hundreds of thousands of runs. In some embodiments, runs may be consolidated for display, e.g., grouped together (e.g., into sets of 100 runs, 500 runs, 1000 runs, etc.) and statistical representations applied, e.g., box and whisker plots, etc.

In some embodiments, long-term data analysis may include Fault Detection Classification (FDC) 517 analysis. FDC 517 analysis may include utilizing one or more machine learning models. FDC 517 analysis may include supplying current sensor data to a trained machine learning model, e.g., a machine learning model trained using historical sensor data. The machine learning model may be supervised, unsupervised, semi-supervised, etc. Examples of machine learning models that may be used include Gaussian models, artificial neural networks (e.g., deep neural networks, convolutional neural networks, etc.), support vector machines, and so on. FDC 517 analysis may be sensitive to anomalies that SPC 516 analysis is insensitive to, such as various shapes in a time trace with the same average value, a shift in time of a feature in a time trace, a ramp rate, etc. FDC 517 may be used for outlier classification, fault detection, anomaly detection, etc. FDC 517 analysis may compare current data to learned behavior to determine if the current run is an outlier. In training, a machine learning model associated with FDC 517 analysis may recognize anomalous unlabeled time trace data. In some embodiments, substrates with processing operations classified as anomalous may be flagged for further investigation, e.g., more thorough metrology than is typically performed on a substrate.

In embodiments, one or multiple processing windows (e.g., which may be moving windows or sliding windows) may be set for review of spikes and/or violations of one or more rules. Each processing window may be associated with its own rule or set of rules. For example, processing windows may be associated with minimums and/or maximums of sensor values, of averages of sensor values, of medians of sensor values, and/or of other statistical measures of sensor values. Different processing windows may be applied to the same set of sensor measurements, where each processing window may be tuned to detect different types of problems or anomalies. Operating window analysis may be performed in association with processing stage 519 data and/or long-term stage 520 data.

FIG. 5C is a flow diagram depicting use of a comprehensive analysis module, according to some embodiments. A process expert 530 (e.g., subject matter expert, a process team, etc.) may generate a substrate processing recipe in a recipe creation 532. The process recipe may be generated in accordance with one or more BKMs. The processing recipe may be associated with a target output product. The processing recipe may include substrate etching, material deposition, etc. The processing recipe may include many variables, such as target temperatures, pressures, flow rates, plasma intensities, etc. Any of the processing recipes may have time dependent target values. The processing recipe may include a plurality of values of any property, changing in time.

The recipe of recipe creation 532 may be intended for one or more process tools, one or more process chambers, etc. Data associated with the recipe, the intended tools/chambers, an intended output product, etc., may be provided to comprehensive analysis module 538.

Comprehensive analysis module 538 may generate in accordance with one or more rules. Comprehensive analysis module 538 may include one or more models. Comprehensive analysis module 538 may flag violations of BKMs as anomalous. BKMs may be provided to comprehensive analysis module 538 by a user 539. User 539 may include one or more subject matter experts. User 539 may include one or more experts on productivity, chamber performance, substrate performance, etc. Process experts (e.g., process expert 530) may contribute to operations, BKMs, or the like of comprehensive analysis module 538.

Comprehensive analysis module 538 may perform analysis associated with recipe creation 532. In some embodiments, the analysis module may operate on a recipe input. For example, best known methods (BKMs) may indicate certain settings that are known to not enable peak chamber performance, combinations of settings that do not enable peak performance, etc. The comprehensive analysis module may be used to analyze processing equipment constants. For example, processing equipment may translate target input (e.g., a target start time and volume of gas flow) to physical processes in hardware (e.g., timing and breadth of valve actuation). The comprehensive analysis module may ensure that equipment constants conform with BKMs. Operations associated with providing recipe data to comprehensive analysis module 538 may be included in recipe checking operations. Operations associated with providing equipment constants and other hardware data to comprehensive analysis module 538 may be included in equipment constant monitoring operations.

In some embodiments, recipe checking procedures may occur before any processing is performed, e.g., before any substrates are processed according to the recipes. Equipment constant monitoring operations may occur before any processing is performed. Recipe checking and equipment constant monitoring operations may be performed, modified, adjusted, re-performed, etc., at any time. Recipes, equipment constants, hardware parameters, etc., may be adjusted subject to output of comprehensive analysis module 538.

Substrate processing 534 may be performed with input from recipe creation 532. A recipe, equipment constants, other manufacturing parameters, etc., may be utilized in processing one or more substrates. The recipe, equipment constants, manufacturing parameters, etc., may have been updated (e.g., before processing in accordance with the processing recipe) due to output of comprehensive analysis module 538.

In some embodiments, further analysis may be performed after some number of substrates has been processed. In some embodiments, analysis may be performed on data from a small number of substrates (e.g., 1-5 substrates). In some embodiments, the comprehensive analysis module may automatically evaluate operations performed (e.g., using chamber sensor data) against BKMs. In some embodiments, BKMs may evolve, and the comprehensive analysis module may be updated as appropriate, e.g., as new best practices are discovered. In some embodiments, the comprehensive analysis module may be updated to incorporate additional knowledge of a user.

Substrate processing 534 may continue as more substrates are generated. Over a period of time, processing may generate data associated with long-term processing 536. In some embodiments, the comprehensive analysis module may be used for longer-term analysis, e.g., over many wafers, many operating hours, etc. Data associated with long-term processing 536 may be or include similar data to substrate processing 534. For example, data associated with long-term processing 536 may include sensor data. Data associated with long-term processing 536 may include different data than data associated with substrate processing 534. For example, long-term processing 536 may include statistical data, such as statistical data associated with one or more processing operations, one or more processing procedures, a number of substrate processed over a period of time, etc. Drifts, aging, component failure, performance, etc., may be tracked long-term. Data associated with long-term processing 536 may be batched and provided to comprehensive analysis module 538 periodically. Data associated with long-term processing 536 may be statistically collected and provided to comprehensive analysis module 538 after a target span of time, a target number of processed substrates, upon user request, or the like.

Comprehensive analysis module 538 may perform analysis periodically, upon request from a user, etc. Comprehensive analysis module 538 may perform additional analysis upon reception of additional data, e.g., associated with a newly processed substrate. Comprehensive analysis module 538 may consolidate analysis results into reports. Reports may be generated periodically, e.g., weekly, monthly, etc. Reports may be generated upon user request.

In some embodiments, performance of the analysis module may be analyzed in a module review 540. Module review 540 may determine whether accurate predictions were made by comprehensive analysis module 538. Module review 540 may determine whether BKMs associated with comprehensive analysis module 538 are appropriate, should be updated, or the like. Module review may be undertaken by a processing device, e.g., a processing device may determine whether one or more outputs of comprehensive analysis module 538 are valid. Module review may be included as part of the comprehensive analysis module 538, e.g., comprehensive analysis module 538 may generate one or more reports related to performance of comprehensive analysis module 538. Module review 540 may include review of results of comprehensive analysis module 538 by one or more user, e.g., subject matter experts, a process team, a productivity team, any of the users involved in recipe creation or providing BKMs to comprehensive analysis module 538, etc.

Comprehensive analysis module 538 may be updated in view of the performance analysis. Comprehensive analysis module 538 may be deployed for further use if module review 540 concludes the analysis module is performing adequately. Module review 540 may feedback into comprehensive analysis module 538. Module review 540 may update and/or recommend updates to comprehensive analysis module 538. Module review 540 may feedback into recipe creation 532. Module review 540 may update and/or recommend updates to recipe creation 532. Module review 540 may feedback into future substrate processing 534, e.g., by updating and/or recommending updates to equipment constants or other manufacturing system parameters.

FIG. 6 is a diagram depicting an example set of sample operating windows 600, according to some embodiments. Operating windows 600 may be utilized in performing operating window analysis. Operating window analysis may be associated with analysis of substrate processing. Operating window analysis may be associated with long-term stage data processing.

In some operations, it may be in accordance with one or more BKMs to ensure that some data point value be within an operating window over a duration of time. For example, a sensor may have an ideal operating range. An operating range may be found in manufacturers guidelines, developed over time, presented by a subject matter expert, determined based on analysis of long-term stage data, or the like. Finer control of a component may improve performance. For example, performance of an actuator may be best within a narrow range of openings, somewhat less accurate within a wider range of openings, and least accurate within a further widest range of openings.

A value associated with a process component may operate at a threshold level of performance within different operating windows over different spans of time. For example, it may be acceptable for a value (e.g., sensor response) to be within a first window of values for the duration of a processing operation, but for shorter durations within the operation duration a different (e.g., less stringent) window of values may be acceptable. A variety of operating window durations, along with acceptable values of output associated with each of the durations, may be associated with a number of components, values, process variables, or the like.

FIG. 6 shows a diagram of example acceptable operating windows 600 for a component of a processing chamber. The y-axis depicts a percentage scale of a full operating range of the component. The x-axis are a set of distinct window duration values. Example operating windows 600 are depicted as maximum acceptable values. For example, over a large time duration, a statistical measure (e.g., average, median, variance, etc.) of response may be targeted to satisfy a fairly stringent threshold condition. Example operating windows 600 include an operating window of duration 100, with a maximum acceptable value (e.g., maximum average of all data points within the duration window) of about 10%. A comprehensive analysis module may ensure that the operating window is upheld. For example, the comprehensive analysis module may check one or more windows of sensor data, determine a statistical metric of data values in the windows, and compare the value of the statistical metric to values of the operating window.

A set of data (e.g., a time trace associated with a sensor) may be subject to multiple operating window analyses. Trace data may be broken up into segments related to an operating window duration. Each segment may be analyzed for violations, anomalies, etc. A sliding window may be utilized, where each combination of data points of approximately the target window duration is analyzed for violations, anomalies, etc. A hybrid method utilizing overlapping windows may be utilized. Window placements (e.g., selection of which set of data points to analyze) may be determined in any convenient manner. Window placements may be systematic, random, etc. A target number of window replacements may be generated for a window duration, for each window duration, etc. Window placements may determine which portion of the data (e.g., operational data, trace data, etc.) are utilized for determining whether a statistical metric satisfies a threshold condition.

A set of data may be analyzed via multiple window durations. For example, a sensor response may be checked for short term violation (e.g., the process may be flagged as anonymous if the average of a property measured by a sensor over any 1 second period is above 90% of a maximum value associated with the sensor). The sensor response may be checked for process operation length violations (e.g., the value of the average sensor response of an entire operation is to be under a target value). The sensor may further be utilized for operating window analysis of intermediate duration time windows.

A set of data may be analyzed via multiple statistical metrics. An operating window may be associated with a statistical metric. A second operating window, of the same or different duration, may be associated with maintaining a value of a different statistical metric. For example, a set of operating window durations, each associated with an average value, and a second set of operating window durations, each associated with a standard deviation value, may be used in analyzing a set of trace sensor data.

Example operating windows 600 are maximum bounded, e.g., any response between zero and a selected (e.g., according to BKMs) max is acceptable. Some operating windows may be minimum bounded, minimum and maximum bounded, etc.

As depicted in FIG. 6, for any 0.5 second window, a response is to be below 90% of maximum, for any 2 second window, the response is to be below 80% of maximum, for any 5 second window, the response is to be below 50% of maximum, etc. Operating window analysis may include sliding differently sized windows (e.g., 0.5 seconds in duration) throughout a time trace associated with the operating window parameters, and determining the value of the target statistical metric on the points within the window. The result may be recorded and the window advanced to check a new selection of data points. The advanced window may overlap the original window, e.g., may share data points with the original window. Windows of various sizes (e.g., 0.5 seconds, 2 seconds, 5 seconds, 10 seconds, 20 seconds, 50 seconds, and 100 seconds as shown in FIG. 6) may be used in analogous processes. Data points (e.g., averages of time trace data points) falling outside the acceptable range of the sample operating window appropriate to their window size may be flagged, data indicative of them provided to a user, corrective actions initiated based on them, etc.

In some embodiments, sample operating window analysis may assist in diagnosing root causes of faults, e.g., violations in shorter time windows but not longer time windows may indicate sudden condition changes, may flag hardware for damage inspection, etc. Violations in longer time windows may indicate component drift, sensor drift, chamber aging and/or drift, etc. In some embodiments, operating windows may be input by a user. In some embodiments, operating window parameters may be generated from BKMs. In some embodiments, operating window parameters may be generated automatically, e.g., based on historical data.

Some operating window analysis may be performed on long-term stage data. Performing operating window analysis on long-term stage data may enable determination of anomalous chamber behavior, component behavior, substrate performance, etc. For example, a single processing procedure may be associated with acceptable limits for one or more measured values. An average of all processing procedures over a day, week, or another duration may be subject to more stringent limits, analogous to the case of sensor data.

Operating window durations may be generated via various schemes. In some cases, operating window duration selection may be automated. A target number of window durations may be utilized, e.g., in view of desired sensitivity to various potential faults, in further view of cost, time, and processing power for the analysis, etc. It may be understood (e.g., via BKMs) that violations associated with a wide range of durations are relevant. A linear function may be utilized to populate a target number of window durations between a minimum duration of interest and a maximum duration of interest. It may be understood that violations of relatively short duration, relatively long duration, both, neither, etc., are of interest for a target process value. A target number of window durations may be generated utilizing a different function to relate window number do window durations, such as exponential functions, logit functions, sigmoidal functions, piecewise functions, etc. A comprehensive analysis module may be updated (e.g., via module review) to change operating window durations for operating window analysis in view of analysis performed over a period of time.

In some embodiments, different window length functions may generate window lengths of various distributions. Window durations of various lengths may be useful for detecting various anomalous behaviors. For example, short duration windows may be used to detect short duration spike behavior of a component. Longer duration windows may be useful for SPC, to detect long-term drift or failure of components etc.

FIG. 7 depicts an example graphical user interface (GUI) 700 for interacting with a comprehensive analysis module. GUI 700 may display results received from the comprehensive analysis module to a user. GUI 700 may be used by a user to provide instructions to the comprehensive analysis module. GUI 700 may be designed to quickly provide information about one or more substrate processing procedures. GUI 700 may provide information about potential anomalies. GUI 700 may synthesize rules, BKMs, recipe data, sensor data, long-term data, internal knowledge, etc., GUI 700 may provide to a user a explanation of performance of a tool, chamber, fleet, etc. GUI 700 may present analysis results. GUI 700 may present detected anomalies. GUI 700 may summarize performance of a selection of chambers, tools, etc.

GUI 700 may include summary panel 702. Summary panel 702 may provide quick information about various processing equipment. Summary panel 702 may enable a user to select a set of processing equipment from a list for further investigation. Example summary panel 702 provides a list of process chambers, but tools, facilities, components, or other sets of equipment may be listed instead or additionally. Summary panel 702 may include a visualization of a metric related to performance of the listed equipment. For example, icon 704 associated with each of the listed processing equipment may provide a summary of performance. Icon 704 may include a numerical indication of performance, a letter indication, a grade, or a visual indication. Icon 704 may use patterns, colors, or other visual indicators to provide a quick summary of performance of process equipment. Icon 704 may be selected based on overall performance of processing equipment, e.g., based on a number of detected anomalies or violations, based on severity of detecting anomalies, based on a weighted combination of violations, etc. Some types of violations may be selected to contribute to a summary of equipment performance more than other types, e.g., based on subject matter expertise, based on historical data, based on previous operations of a comprehensive analysis module, etc. Performance summaries may be presented for a fleet of chambers, subsystems of a chamber, components of a chamber, groups based on chamber design, a class of recipe, etc. A user may quickly ascertain if a chamber, subsystem, or other set of equipment is experiencing a large number of anomalies. A user may view and/or request further analysis based on the summary icon 704.

GUI 700 includes equipment analysis panel 706. Analysis panel 706 may provide additional information associated with performance of a selected process equipment. Analysis panel 706 may present anomalies detected arranged by operation (e.g., step), processing subsystem (e.g., pressure subsystem), analysis tools (e.g., FDC analysis, operating window analysis), severity (e.g., number of violations detected), etc. In some embodiments, a graphic 708 may provide visual cues to indicate anomalies. Graphic 708 may be a plot which provides information about anomalies, faults, performance, or the like. In some embodiments, a two-dimensional graph may depict an indication of performance along two axes. For example, graphic 708 includes subsystems on the y-axis and operation number (e.g., step number) on the x-axis. Icons placed on graphic 708 may indicate performance of the corresponding subsystem during the operations. Icons may be differentiated by shape, color, pattern, etc. Groupings of icons may indicate particular problems. For example, horizontal groupings of icons indicating a large number of violations or anomalies may indicate a failing subsystem in example graphic 708. In some embodiments, a graphical user interface may output an indication of how many recipe runs include failures, how many operations (e.g., steps) include failures, may organize data by chamber, fleet, etc., for various levels of insight. Specific data presented by graphic 708, visual style of the presentation, etc., may be selected by a user, e.g., via analysis display settings panel 710.

Traditionally, some subset of processed substrates are sampled (e.g., metrology is performed on those substrates) to test the devices and/or features on those substrates. Such testing is often destructive of the substrate, and is generally time consuming. Accordingly, only a small fraction of the processed substrates are generally sampled. Traditionally, the sampling of substrates is performed essentially at random. In embodiments, the system provides a recommendation for one or more substrates to be sampled. The system may identify substrates for which one or more anomalies occurred. The system may identify substrate for which a target number of BKMs were violated. Such substrates may have a higher likelihood of failing one or more metrology tests. Accordingly, such substrates can be useful substrates to perform metrology on. In some embodiments, a user can determine which substrate or substrates to perform metrology on based on the user interface. In some embodiments, the user interface outputs a recommendation for one or more substrates to test.

GUI 700 may provide more detailed information in addition to summarized performance data. Trace data display panel 712 may display specific trace data, golden (e.g., acceptable) trace data, averaged or median trace data, etc. Trace data display panel 712 may display trace data associated with graphic 708. Trace data display panel 712 may further display an operating window 714. GUI 700 may provide substrate performance data, if known. For example, metrology display 716 may be used for a user to inspect some measurements of one or more substrates.

In some embodiments, the graphical user interface may display a code via code panel 718. GUI 700 may display an alphanumeric code. GUI 700 may display a code comprising characters. In some embodiments, the graphical user interface may display a quick response (QR) code. GUI 700 may display a bar code, another visual code, or another type of code. In some embodiments, the code may be generated by the comprehensive analysis module. The code may contain information indicating aspects displayed on the graphical user interface. For example, the code may encode a particular run, tool, recipe, operation, time offset into a run, etc. The code may used by a user to quickly access the same or similar data, analysis, display, or the like, as is presented by GUI 700. The code may be utilized by a user to navigate to a target visual representation, target data, target chamber of equipment, etc. The code may be used to quickly access data, analysis, visualizations, etc., of interest to a user. The code may be implemented by another device, e.g., upon being typed in by a user, scanned by a user, etc. The code may be used to quickly communicate data of interest to another user, e.g., allow another user to quickly reproduce data, graphics, information, reports, etc., for further analysis.

In some embodiments, outputs of the comprehensive analysis module may be further mined for signatures of failure mechanisms. For example, metrology and comprehensive analysis data (e.g., comprehensive analysis module violation data) may be provided to a machine learning model. The machine learning model may be trained to correlate violations (e.g., violation patterns) to failure modes. Corrective actions may be recommended based on machine learning classification of analysis module data.

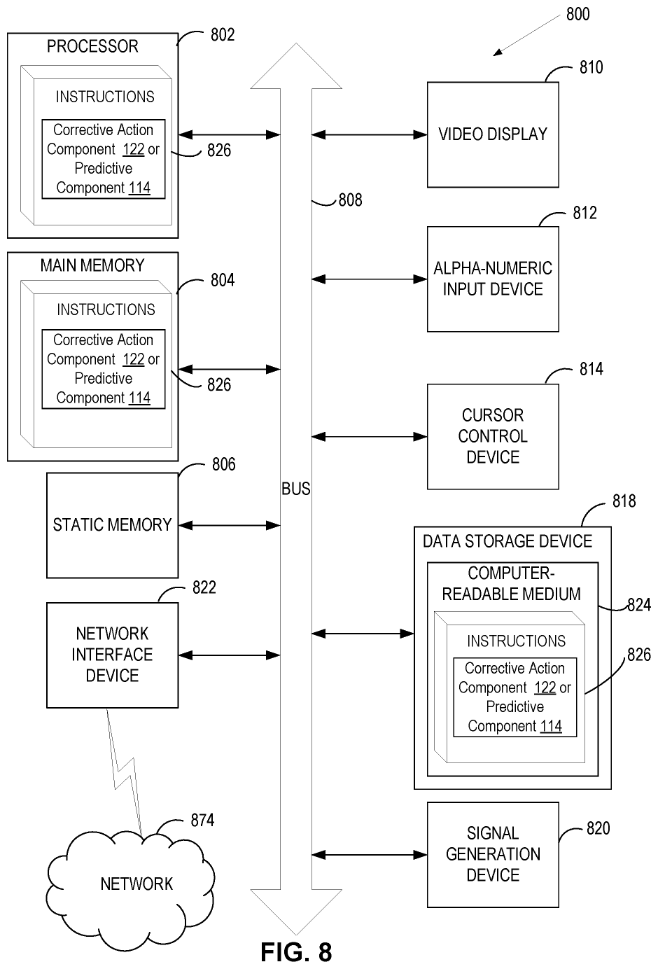

FIG. 8 is a block diagram illustrating a computer system 800, according to some embodiments. In some embodiments, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 may include a processing device 802, a volatile or main memory 804 (e.g., Random Access Memory (RAM)), a non-volatile or static memory 806 (e.g., Read-Only Memory (ROM) or Electrically-Erasable Programmable ROM (EEPROM)), and a data storage device 818, which may communicate with each other via a bus 808.

Processing device 802 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 800 may further include a network interface device 822 (e.g., coupled to network 874). Computer system 800 also may include a video display unit 810 (e.g., an LCD), an alphanumeric input device 812 (e.g., a keyboard), a cursor control device 814 (e.g., a mouse), and a signal generation device 820.

In some embodiments, data storage device 818 may include a non-transitory computer-readable storage medium 824 (e.g., non-transitory machine-readable medium) on which may store instructions 826 encoding any one or more of the methods or functions described herein, including instructions encoding components of FIG. 1 (e.g., predictive component 114, corrective action component 122, model 190, etc.) and for implementing methods described herein.

Instructions 826 may also reside, completely or partially, within volatile memory 804 and/or within processing device 802 during execution thereof by computer system 800, hence, volatile memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1. A method, comprising:
receiving, by a processing device, first data indicative of a processing recipe;
receiving second data, wherein the second data comprises operational data associated with the processing recipe;
receiving third data, wherein the third data comprises historical data associated with the processing recipe;
performing analysis indicative of performance of a processing chamber based on the first, second, and third data; and
causing performance of a corrective action in view of the analysis.

2. The method of claim 1, wherein analysis comprises recipe checking and equipment constant monitoring.

3. The method of claim 1, wherein analysis comprises operating window analysis, wherein operating window analysis comprises performing a first statistical analysis of data points within a first time window, performing a second statistical analysis of data points within a second time window, and comparing a result of the first statistical analysis to first one or more thresholds and a result of the second statistical analysis to second one or more thresholds, wherein the second time window is of different duration than the first time window.

4. The method of claim 1, wherein causing performance of a corrective action comprises:
displaying a visual representation of analysis results on a graphical user interface; and
generating a code identifying anomalous processing chamber behavior.

5. The method of claim 1, wherein analysis comprises:
providing the second data as input to a trained machine learning model; and
receiving from the trained machine learning model fourth data indicative of anomalous behavior of the processing chamber.

6. The method of claim 1, further comprising:
determining that the second data comprises one or more indications of an anomaly associated with a substrate processed by the processing chamber; and
recommending additional analysis of the substrate based on the one or more indications of an anomaly.

7. The method of claim 1, wherein performing analysis indicative of performance of the processing chamber based on the first, second, and third data comprises:
comparing first data to a plurality of rules associated with processing recipes, wherein the comparing is performed before the processing recipe is used in processing a substrate;
performing one or more tests upon the second data, wherein the one or more tests are performed after a first number of substrates have been processed in the processing chamber using the processing recipe; and
performing one or more tests upon the third data, wherein the one or more tests are performed after a second number of substrates have been processed in the processing chamber using the processing recipe, and wherein the second number is greater than the first number.

8. A method, comprising:
receiving, by a processing device, first data, wherein the first data comprises a processing recipe;
performing first analysis on the processing recipe, wherein the analysis comprises comparing the first data to one or more Best Known Methods (BKMs) related to the first data;
receiving second data, wherein the second data comprises first operational data generated from a first number of processing runs using the processing recipe;
performing second analysis on the second data;
receiving third data, wherein the third data comprises second operational data generated from a second number of processing runs using the processing recipe;
performing third analysis on the third data, wherein the second number is greater than the first number; and
causing performance of a corrective action based on the first analysis, second analysis, and third analysis.

9. The method of claim 8, wherein the first analysis comprises recipe checking and equipment constant monitoring.

10. The method of claim 8, wherein the second analysis comprises operating window analysis, wherein operating window analysis comprises:
defining a first window duration;
selecting a first plurality of window placements, wherein each of the first plurality of window placements is of the first window duration;
determining a first plurality of statistical metrics, wherein each of the first plurality of statistical metrics is associated with data within one of the first plurality of window placements;
defining a second window duration;
selecting a second plurality of window placements, wherein each of the second plurality of window placements is of the second window duration;
determining a second plurality of statistical metrics, wherein each of the second plurality of statistical metrics is associated with data within one of the second plurality of window placements;
comparing the first plurality of statistical metrics to a threshold value; and
comparing the second plurality of statistical metrics to a threshold value.

11. The method of claim 8, wherein the operational data comprises trace sensor data, and wherein the second analysis comprises determining whether values of the trace sensor data satisfy a threshold condition.

12. The method of claim 8, wherein the first operational data comprises trace sensor data, and wherein the second operations data comprises one or more statistical metrics associated with the trace sensor data.

13. The method of claim 8, wherein the third analysis comprises:
providing the third data to a trained machine learning model, wherein the trained machine learning model is configured to detect one or more faults based on operational data;
receiving output from the trained machine learning model, wherein performance of the corrective action is based on the output from the trained machine learning model.

14. The method of claim 8, wherein the corrective action comprises one or more of:
providing an alert to a user;
updating a processing recipe;
updating an equipment constant;
scheduling maintenance of manufacturing equipment; or
updating a best known method associated with the first analysis, second analysis, or third analysis.

15. The method of claim 8, wherein the corrective action comprises providing a visualization of the first analysis, the second analysis, or the third analysis via a graphical user interface (GUI).

16. The method of claim 15, wherein the GUI further comprises a code, wherein the code may be utilized to direct a second user interface to display a visualization of the first analysis, the second analysis, or the third analysis.

17. A non-transitory machine-readable storage medium, storing instructions which, when executed, cause a processing device to perform operations comprising:
receiving first data indicative of a processing recipe;
receiving second data, wherein the second data comprises operational data associated with the processing recipe;
receiving third data, wherein the third data comprises historical data associated with the processing recipe;
performing analysis indicative of performance of a manufacturing system based on the first, second, and third data; and
causing performance of a corrective action in view of the analysis.

18. The non-transitory machine-readable storage medium of claim 17, wherein the corrective action comprises:
displaying a visual representation of analysis results on a graphical user interface; and
generating a code associated with navigating to the visual representation of analysis results.

19. The non-transitory machine-readable storage medium of claim 17, the operations further comprising:
determining that the second data comprises one or more indications of an anomaly associated with a substrate processed by the manufacturing system; and
recommending additional analysis of the substrate based on the one or more indications of an anomaly.

20. The non-transitory machine-readable storage medium of claim 17, wherein performing analysis indicative of performance of the manufacturing system comprises:
comparing first data to a plurality of rules associated with processing recipes;
performing one or more tests upon the second data, wherein the second data is associated with a first number of substrates processed using the processing recipe; and
performing one or more tests upon the third data, wherein the third data is associated with a second number of substrates processed using the processing recipe, and wherein the second number is greater than the first number.
